(19) United States
(12) Patent Application Publication
(10) Pub. No.: US 2005/0144290 A1
(43) Pub. Date: Jun. 30, 2005

(54) Arbitrary java logic deployed transparently in a network

(76) Inventors: Rizwan Mallal, Waltham, MA (US); Jesse D. Byler, Lancaster, MA (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/909,927

(22) Filed: Aug. 2, 2004

Related U.S. Application Data
(60) Provisional application No. 60/492,177, filed on Aug. 1, 2003.

(51) Int. Cl. G06F 15/16

(52) U.S. Cl. 709/227

(57) ABSTRACT

A networking appliance having a Java proxy engine that provides client-side transparency, thereby enabling a back-end server to see the original source IP address of the client without having to use the BSD socket system call interface, wherein the network appliance is able to use high level Java code to achieve flexibility and rapid prototyping of modifications to the network appliance.

### CROSS-REFERENCE TO RELATED APPLICATIONS

This application claims priority to and incorporates by reference provisional patent application Ser. No. 60/492,177, filed Aug. 1, 2003.

### BACKGROUND OF THE INVENTION

1. Field of the Invention

This invention relates generally to a hardware network appliance running Java software and providing connections between a back end server and a client, wherein it is desirable for the back end server to be able to see the original source IP address of the client, instead of the IP address of the network appliance, and wherein it is desirable to achieve this client-side transparency without using the Berkeley Software Design™ (BSD™) socket system call interface.

2. Description of Related Art

The state of the art in client-side transparency is characterized by a network appliance relying on a native BSD socket system call interface that requires support from the native kernel. It is generally desirable to take advantage of a socket because the programmer needs only to read and write data to and from the socket, and then manipulate the socket as desired, in order to transport data across a network. This eliminates much of the complication of sending TCP/IP messages across a network.

Accordingly, the BSD socket system call interface was developed to enable communication with and control of sockets. Programmers rely on low level C code to achieve client-side transparency through a hook to the BSD socket system call interface. Thus, the socket use is relatively inflexible and coded at a relatively low level in C in order to achieve the objective of client-side transparency.

It would be an advantage over the prior art to provide a network appliance capable of intercepting network traffic and providing client-side transparency, thus enabling a back-end server to see the original source IP address of a client, without relying on low level programming. It would be another advantage to achieve client-side transparency without relying on calls to the BSD socket system call interface.

### BRIEF SUMMARY OF THE INVENTION

It is an object of the present invention to provide a network appliance that enables client-side transparency to a back-end server without making calls to the BSD socket system call interface.

It is another object to provide a network appliance that can respond to changes in functionality more rapidly than a C coded device, thereby achieving greater flexibility in architecture.

In a preferred embodiment, the present invention is a networking appliance having a Java proxy engine that provides client-side transparency, thereby enabling a back-end server to see the original source IP address of the client without having to use the BSD socket system call interface, wherein the network appliance is able to use high level Java code to achieve flexibility and rapid prototyping of modifications to the network appliance.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of services that are arranged in accordance with the principles of the present invention.

FIG. 2 is a flow chart of the operations that are performed in an embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a network appliance that intercepts network traffic. In the prior art, a proxy engine in the network appliance that is written in C code is programmed to perform desired functions. For example, consider the general flow of network data.

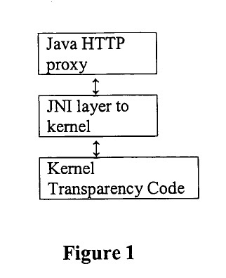

FIG. 1 shows software elements of a network appliance 10. This network appliance 10 can be configured in an in-line mode wherein network traffic must pass through it to get to another side, or in a proxy mode. The goal of the present invention is to enable client-side transparency, wherein a back-end server is able to see the original source IP address of the client even though there is an intervening network appliance, but without having to make BSD socket calls. By avoiding BSD socket calls, the present invention avoids having to use the cumbersome low level C code to control socket functions. In other words, by enabling client-side transparency to occur using high level Java code, changes to the network appliance can be made quickly and easily by avoiding use of the C programming language.

The present invention overcomes several drawbacks to the prior art scenario described above. The advantages of the present invention will be described while referring to FIG. 1.

FIG. 1 is a block diagram of the basic elements of the present invention. These elements include a Java HTTP proxy 12, Java Native Interface (JNI) layer access to the kernel 14, and kernel transparency code 16.

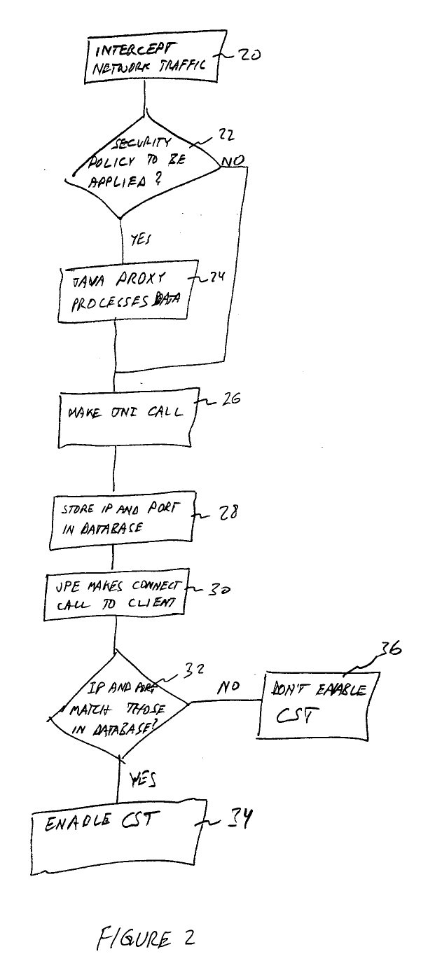

An example of the operation of these elements of the present invention will be described using the example of performing security operations on intercepted network traffic and as will be described in FIG. 2.

Consider a network appliance that is operating either in an in-line mode where network traffic must pass through it to get to another side, or in a proxy mode. Network traffic is intercepted in step 1 (20) by the network appliance. A TCP/IP packet enters an Ethernet port of the network appliance. The network appliance compares the TCP/IP packet to security policies of the network appliance in step 2 (22). If a security policy must be applied, the TCP/IP packet is sent up to the Application layer. In this layer, the Java proxy engine processes a data portion of the TCP/IP packet in step 3 (24). Once the security functions have been applied, such as signing, verification, encryption, etc., the Java proxy engine is ready to send the data back to the back-end server.

At this time in the process, the Java proxy engine has the back-end server's IP and TCP port addresses. The desire now is to connect to the back end server with the original source IP. This original source IP address should still be present at the connection. It is important to note that the Java proxy engine has no access to the BSD socket system call interface. Thus, the Java proxy engine cannot enable client-side transparency.

The Java proxy engine makes a special Java Native Interface (JNI) call in step 4 (26) with the parameters being <client IP, client port, backend IP, backend port>. These parameters are then stored in a kernel transparency database in step 5 (28). The Java proxy engine makes an ordinary high level HTTP URL connect call to the client IP and client TCP ports in step 6 (30). The kernel TCP_CONNECT code has a hook where it intercepts the call and determines if the destination IP and destination TCP ports match the ports saved in the kernel transparency database in step 7 (32). If there is a match then it is desirable to obtain client side transparency for this connection in step 8 (34). Accordingly, the destination IP and TCP ports are replaced with the actual back-end server's IP and TCP ports. In addition, the client IP address is replaced with the original client's IP address which is also stored in the kernel transparency database.

This process has several advantages over the prior art. First, a Java coded proxy engine is performing this operation. A Java coded proxy engine enables rapid prototyping of this function instead of having to use C code. Furthermore, this step is performed at relatively high speeds, thus performance is not being sacrificed by using the Java coded proxy engine. In addition, using a Java coded proxy engine means that the network appliance maintains its operating system platform independence because of the ubiquitous availability of Java virtual machines in operating systems.

It is envisioned that the Java and C proxy engines will be ported to a software platform on a desktop PC or a notebook PC running Windows 2000 or Windows XP. However, this should not be considered a limiting factor, and the present invention can be ported to other operating systems and other hardware platforms as well.

The advantages of the present invention over the prior art are substantial. The present invention is versatile because of its platform independence that is enabled by the use of the Java language. Use of the Java language inherently means that the prototyping of changes and improvements is rapid because of the ease of use of the Java language. Furthermore, high speed performance is maintained because of the use of the Java language.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A method for providing client-side transparency without resorting to using a socket system call interface, said method comprising the steps of:
1) intercepting data being transferred from a client to a server across a computer network;
2) obtaining an address and port of the client without relying on a socket system call; and
3) enabling client-side transparency when desired.

2. The method as defined in claim 1 wherein the method further comprises the step of obtaining an IP and a TCP port address of the client without using a socket system call.

3. The method as defined in claim 2 wherein the method further comprises the step of obtaining the client IP address and the TCP port by making a Java Native Interface (JNI) call.

4. The method as defined in claim 3 wherein the method further comprises the step of storing values including client IP, client port, server IP, and server port information in a database.

5. The method as defined in claim 4 wherein the method further comprises the step of performing an HTTP URL connect call to confirm client IP and client TCP port addresses.

6. The method as defined in claim 5 wherein the method further comprises the step of comparing a destination IP and destination TCP port address to the client IP and client TCP port addresses stored in the kernel transparency database.

7. The method as defined in claim 1 wherein the method further comprises the step of determining if client-side transparency can be performed by only using Java language calls.

8. The method as defined in claim 7 wherein the method further comprises the step of only using high level Java classes without having to rely on low level Java information.

9. The method as defined in claim 8 wherein the method further comprises the step of programming the steps of determining if client-side transparency can be performed using the Java programming language.

10. The method as defined in claim 9 wherein the method further comprises the step of enabling rapid prototyping of modifications to the steps of determining if client-side transparency can be performed by using the Java programming language.

11. The method as defined in claim 4 wherein the method further comprises the step of storing values including client IP, client port, server IP, and server port information in a kernel transparency database.

12. The method as defined in claim 1 wherein the method further comprises the step of performing security operations on the intercepted data before providing client-side transparency.

13. A method for providing flexible and transparent connections between a client and a server without relying on a socket system call interface, said method comprising the steps of:
1) programming all steps of the method using a proxy engine that does not require access to a socket system call interface in order to determine an IP address and a TCP port of a client;
2) receiving at least one network packet from the client;
3) obtaining the IP address and the TCP port of the client by using the proxy engine; and
4) enabling client-side transparency when desired.

14. The method as defined in claim 13 wherein the method further comprises the step of using a Java proxy engine as the proxy engine.

15. The method as defined in claim 14 wherein the method further comprises the step of providing a client-side transparency hook in the Java proxy engine in order to obtain the IP address and TCP port of the client.

16. The method as defined in claim 15 wherein the method further comprises the step of using a native kernel to assist the Java proxy engine in implementing client-side transparency.

17. The method as defined in claim 16 wherein the method further comprises the step of using the Java proxy engine to perform a Java Native Interface (JNI) call to thereby obtain the IP address and TCP port of the client.

18. The method as defined in claim 17 wherein the method further comprises the step of enabling rapid prototyping of modifications to the Java proxy engine by using only high level Java language calls instead of low level system socket interface calls.

19. The method as defined in claim 18 wherein the method further comprises the step of intercepting a call from the Java proxy engine to the client using kernel TCP-CONNECT code to thereby determine if the intercepted IP address and TCP port are the same as the client IP address and the TCP port stored in a kernel transparency database.

20. A system for providing client-side transparency without resorting to using a socket system call interface, said system comprised of:
at least one client having an IP address and a TCP port,
at least one server;
a network appliance for intercepting data packets transferred to and from the at least one server;
a proxy engine for obtaining an IP address and TCP port of the client without relying on a socket system call, and for implementing client-side transparency from the at least one client to the at least one server.

21. The system as defined in claim 20 wherein the proxy engine is a Java proxy engine.

22. The system as defined in claim 21 wherein the system is further comprised of a database for storing client IP, client port, server IP, and server port information.

23. The system as defined in claim 22 wherein the database is further comprised of a kernel transparency database.
